(19) United States
(12) Patent Application Publication
(10) Pub. No.: US 2025/0165990 A1
(43) Pub. Date: May 22, 2025

(54) Chatbot for Prevention of Online Fraud

(71) Applicant: Bitdefender IPR Management Ltd., Nicosia (CY)

(72) Inventors: Alexandra Daniela BUTINCU, Iasi (RO); Marius Nicolae TIBEICA, Iasi (RO); Iuliana ILASCU, Bucuresti (RO)

(21) Appl. No.: 18/513,750

(22) Filed: Nov. 20, 2023

(51) Int. Cl. G06Q 30/018; G06F 40/35; H04L 51/02

(52) U.S. Cl. CPC G06Q 30/0185; G06F 40/35; H04L 51/02

(57) ABSTRACT

In some embodiments, a fraud prevention system uses a chatbot agent to provide input to a threat analyzer. The chatbot agent converses with a user to identify a security need, guide the user into providing relevant data (e.g., a content of an email, a screenshot of a social media conversation), identify a target object for analysis, and indicate the target object to the threat analyzer. In turn, the threat analyzer applies a battery of tests to determine whether the target object is indicative of online fraud, such as a phishing attempt. The threat analyzer returns a verdict of the analysis to the chatbot agent for communication to the user.

### BACKGROUND OF THE INVENTION

The invention relates to computer security, and in particular to preventing online fraud such as phishing, among others.

Online fraud, especially in the form of phishing and identity theft, has been posing an increasing threat to Internet users worldwide. Sensitive identity information such as user names, IDs, passwords, social security and medical records, bank and credit card details obtained fraudulently by international criminal networks operating on the Internet are used to withdraw private funds and/or are further sold to third parties. Beside direct financial damage to individuals, online fraud also causes a range on unwanted side effects, such as increased security costs for companies, higher retail prices and banking fees, declining stock values, lower wages and decreased tax revenue.

Online fraud is facilitated by the explosive growth of mobile computing and online services, with millions of devices such as smartphones and tablet computers constantly connected to the Internet and acting as potential targets. In a typical example of phishing, a user receives a fraudulent communication masquerading as a legitimate message from a service provider such as a bank, phone company, online retailer, etc. The message may report a fictitious problem with the user's account or recent order and invite the user to contact the respective service provider via a link included in the respective message. The link may lead to a fake interface (e.g., webpage) used by online criminals to steal sensitive data such as login credentials and credit card numbers, among others. Accessing such links may further expose the user to a risk of installing malicious software.

Various security software may be used to detect fraudulent webpages and/or phishing messages. However, using such software may require installing a local security agent on the user's computing device, and may further require a certain level of knowledge about online communications, computer security, and/or types of online threats, which is expected to exceed that of an ordinary user. Furthermore, the methods used by cybercriminals to trick users into revealing sensitive information are continuously changing. Therefore, there is an ongoing interest in developing robust and user-friendly methods of combating online fraud.

### SUMMARY OF THE INVENTION

According to one aspect, a computer system comprises at least one hardware processor configured to execute a chatbot agent and a threat analyzer coupled to the chatbot agent. The chatbot agent is configured to, in response to receiving a natural language (NL) message from a user, formulate a language model prompt according to the NL message, and transmit the language model prompt to a language model (LM) configured to determine an LM reply comprising a reply to the NL message. The chatbot agent is further configured to identify a target object for fraud analysis according to the LM reply, and to transmit an indicator of the target object to the threat analyzer. The threat analyzer is configured to carry out a fraud analysis of the target object to determine whether the target object is indicative of fraud, and to output a result of the fraud analysis to the chatbot agent for transmission to the user.

According to another aspect, a computer-implemented method comprises employing at least one hardware processor of a computer system to execute a chatbot agent and a threat analyzer coupled to the chatbot agent. Executing the chatbot agent comprises, in response to receiving an NL message from a user, formulating an LM prompt according to the NL message, and transmitting the LM prompt to an LM configured to determine an LM reply comprising a reply to the NL message. Executing the chatbot agent further comprises identifying a target object for fraud analysis according to the LM reply, and transmitting an indicator of the target object to the threat analyzer. Executing the threat analyzer comprises carrying out a fraud analysis of the target object to determine whether the target object is indicative of fraud, and outputting a result of the fraud analysis to the chatbot agent for transmission to the user.

According to another aspect, a non-transitory computer-readable medium stores instructions which, when executed by at least one hardware processor of a computer system, cause the computer system to form a chatbot agent and a threat analyzer coupled to the chatbot agent. The chatbot agent is configured to, in response to receiving an NL message from a user, formulate an LM prompt according to the NL message, and transmit the LM prompt to an LM configured to determine an LM reply comprising a reply to the NL message. The chatbot agent is further configured to identify a target object for fraud analysis according to the LM reply, and to transmit an indicator of the target object to the threat analyzer. The threat analyzer is configured to carry out a fraud analysis of the target object to determine whether the target object is indicative of fraud, and to output a result of the fraud analysis to the chatbot agent for transmission to the user.

### BRIEF DESCRIPTION OF DRAWINGS

The foregoing aspects and advantages of the present invention will become better understood upon reading the following detailed description and upon reference to the drawings where:

FIG. 1 shows exemplary components of a system for preventing online fraud according to some embodiments of the present invention.

FIG. 2 illustrates an exemplary conversation interface according to some embodiments of the present invention.

FIG. 3-A shows an exemplary sequence of steps performed by a chatbot agent according to some embodiments of the present invention.

FIG. 3-B shows another exemplary sequence of steps carried out by the chatbot agent according to some embodiments of the present invention.

FIG. 4 shows an exemplary language model (LM) prompt according to some embodiments of the present invention.

FIG. 5 shows an exemplary LM reply according to some embodiments of the present invention.

FIG. 6 illustrates exemplary components of a threat analyzer according to some embodiments of the present invention.

FIG. 7 shows an exemplary sequence of steps carried out by the threat analyzer according to some embodiments of the present invention.

FIG. 8 shows an exemplary hardware configuration of a computer system programmed to execute some of the methods described herein.

### DETAILED DESCRIPTION OF THE INVENTION

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g., data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. A database or knowledgebase herein denotes any organized, searchable collection of data. Computer-readable media encompass non-transitory media such as magnetic, optic, and semiconductor storage media (e.g., hard drives, optical disks, flash memory, DRAM), as well as communication links such as conductive cables and fiber optic links. According to some embodiments, the present invention provides, inter alia, computer systems comprising hardware (e.g., one or more processors) programmed to perform the methods described herein, as well as computer-readable media encoding instructions to perform the methods described herein.

The following description illustrates embodiments of the invention by way of example and not necessarily by way of limitation.

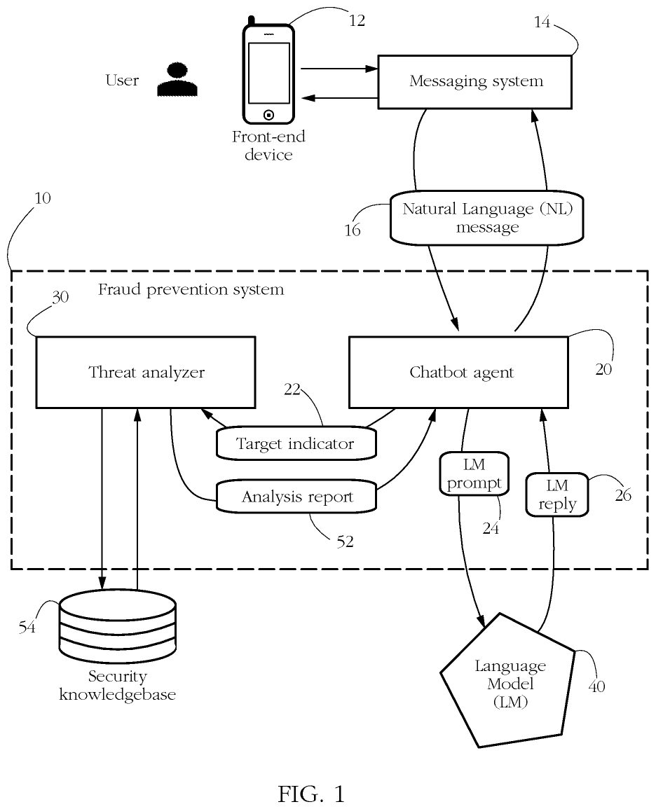

FIG. 1 shows exemplary components of a fraud prevention system 10 according to some embodiments of the present invention. System 10 comprises a chatbot agent 20 and a threat analyzer 30 communicatively coupled to chatbot agent 20. Components of fraud prevention system 10 may be embodied as computer programs executing on a set of hardware processors of a computer system, for instance on a server computer system carrying out fraud-prevention transactions with a plurality of client front-end devices as detailed below. However, a skilled artisan will know that some or all of the functionality of system 10 may also be implemented in dedicated hardware such as field-programmable gate arrays (FPGA) or application-specific integrated circuits (ASIC), or in a combination of hardware and software.

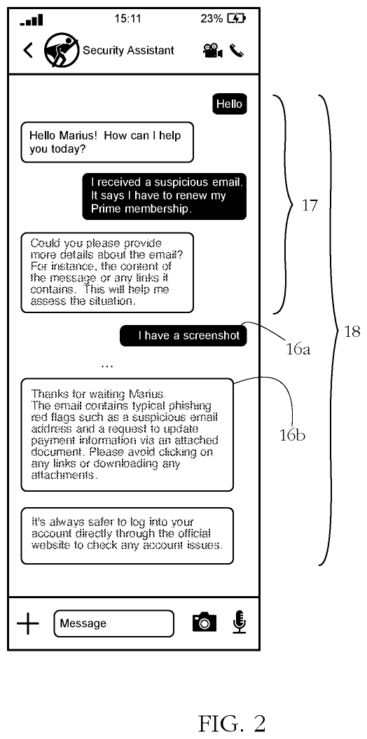

In some embodiments, chatbot agent 20 comprises an artificial intelligence (AI) system configured to carry out a conversation (i.e., exchange of messages) with a user in a natural language (NL) such as English or Chinese, among others. Agent 20 may be further configured to collaborate with threat analyzer 30 to determine according to a content of the respective conversation whether the user is confronted with a computer security threat, such as online fraud, malware, etc. In an exemplary scenario illustrated in FIG. 2, the user may ask chatbot agent 20 whether a message he/she has recently received could be fraudulent. Chatbot agent 20 may then request a copy of the respective message, transmit the suspect message to threat analyzer 30 for analysis, and communicate a result of the analysis back to the user.

Some embodiments of chatbot agent 20 are further configured to provide various other information to the user, for instance answer general questions and offer advice on various computer security subjects such as malicious software, spam, communication privacy, securing online payments, parental control, etc. Chatbot 20 may further advise the user on purchasing computer security software, manage the user's subscriptions to various computer security services, answer billing questions, or in any other way act as a user-friendly interface between the user and a computer security service provider.

To carry out natural language conversations with human users, some embodiments of chatbot agent 20 rely on a language model (LM) 40 to generate synthetic sentences, questions and/or answers. LM 40 comprises an implementation of a computational model of a natural language, for instance a set of artificial neural networks pre-trained on a corpus of text formulated in the respective natural language. Exemplary LMs include probabilistic n-gram models, language models implemented using recurrent neural networks, and large language models (LLM) implemented using generative pre-trained transformers (GPT). In some embodiments, LM 40 is generative in the sense that it is configured to input a sequence of words (e.g., a sentence or a question) and in response, generate a plausible continuation (e.g., another sentence or a reply) to the input sequence of words. The structural and operational details of LM 40 go beyond the scope of the present invention. LM 40 may be implemented using any method known in the art of artificial intelligence. In some embodiments, LM 40 comprises an LLM used by a public and/or commercial chatbot service, such as ChatGPT® from OpenAI, Inc. and Bard® from Google, Inc., among others. In such embodiments, chatbot agent 20 may access LM 40 via a hypertext transfer protocol (HTTP) request addressed to a remote server providing the respective language modelling service.

In some embodiments, threat analyzer 30 comprises a set of modules configured to analyze a target object such as an electronic communication (instant message, email, etc.), sound file (e.g., a recorded voice mail), image (e.g., screen snapshot), or document (e.g., webpage), among others, to determine whether the respective target object is indicative of a computer security threat. The following description will focus on fraud analysis which is directed at determining whether the target object is indicative of online fraud such as phishing, among others. However, a skilled artisan will know that the disclosed systems and methods can be adapted to other kinds of threats such as malicious software, intrusion, etc. Threat analyzer 30 may implement a battery of analysis methods, as detailed below. In conducting fraud analyses, analyzer 30 may rely on a repository of computer security knowledge generically represented herein as security knowledgebase 54. Knowledgebase 54 may include, for instance, a blacklist of Internet domains or network addresses involved in online fraud and a list of keywords characteristic of phishing, among others.

In some embodiments, fraud prevention system 10 interacts with human users via a user interface displayed on a front-end device 12 as illustrated in FIG. 1. Exemplary front-end devices 12 include personal computers, laptops, tablet computers, mobile telecommunication devices (e.g., smartphones), media players, TVs, game consoles, home appliances (e.g., refrigerators, thermostats, intelligent heating and/or lighting systems), and wearable devices (e.g., smartwatches, sports and fitness equipment), among others. A basic user interface according to some embodiments comprises a communication interface enabling the user to interact with fraud prevention system 10 in a natural language, for instance to ask questions, transmit and/or request various data, and/or receive results of various computer security tasks. The communication interface may be integrated with other computer security functionality, for instance with a dashboard for configuring and displaying various security settings and/or for displaying a current security status of a front-end device 12. In exemplary embodiments, the user interface may display an indicator of whether device 12 includes malicious software, an indicator of whether device 12 is currently connected to a virtual private network (VPN), etc. Other exemplary content displayed by the respective user interface may include an indicator of a status and/or details of a user account/service level agreement (SLA)/subscription for using fraud prevention system 10 or other security software. A user interface as described herein may be organized in any manner known in the art, for instance to include a variety of visual elements (e.g., dials, gauges, charts), each indicating a value of a current security setting and/or a value of a monitored quantity. Some visual aspects of the user interface may be customizable, such as a color scheme, position, and content of various screen areas, etc.

In other exemplary embodiments, the user may interact with fraud prevention system 10 via communication interfaces of an online messaging application executing on front-end device 12. Online messaging herein encompasses peer-to-peer messaging as well as messaging via public chatrooms, forums, social media sites, etc. Examples of online messaging include an exchange of short message service (SMS) messages, a sequence of e-mail messages, and a sequence of messages exchanged via instant messaging applications such as WhatsApp Messenger®, Telegram®, WeChat®, and Facebook® Messenger®, among others. Other exemplary online messaging include a content of a Facebook® wall, a chat conducted on an online forum such as Reddit® and Discord®, and a set of comments to a blog post. Exemplary online messaging applications according to embodiments of the present invention include client-side instances of mobile applications such as WhatsApp®, Facebook®, Instagram®, SnapChat® etc., as well as software executing the server side of the respective messaging operations. Other examples of online messaging applications include an email client and an instance of an Internet browser.

For clarity, the present description will focus on communication interfaces that enable the user to carry out a natural language conversation by typing. In other words, exchanges between the user and fraud prevention system 10 described herein are predominantly in text form. However, a skilled artisan will know that this aspect is not meant to be limiting. The described systems and methods may be adapted to processing of audio messages (spoken conversations), video messages, or any combination of carrier media. In such embodiments, chatbot agent 20 may be configured to process the respective type of input directly, or alternatively, to convert the type of input provided by the user into text before applying some of the methods described herein. Furthermore, in some embodiments, a communication interface as described herein may enable the user to attach various types of media files (e.g., an image/screenshot, an audio file such as a recorded voice message, etc.) to a text message.

The exemplary embodiment illustrated in FIG. 1 employs a messaging system 14 to transmit natural language messages 16 between front-end device 12 and fraud prevention system 10. Messaging system 14 generically represents any messaging and electronic communication functionality that goes beyond the scope of the present invention. For instance, messaging system 14 may represent hardware and/or software implementing a conventional electronic communication service such as an email service, short message service (SMS), and instant messaging services like WhatsApp®, iMessage®, and Microsoft Teams®, among others. Messaging system 14 may for instance aggregate messages from multiple front-end devices, route, and/or selectively deliver such messages to their intended destination. In some exemplary embodiments, front-end device 12 may invoke a local instance of a conventional online messaging application to enable the user to send and/or receive NL messages 16 from/to device 12. In turn, chatbot agent 20 may transmit and/or receive the respective messages via application programming interface (API) calls to a remote web service exposed by messaging system 14. The messages themselves may be routed by messaging system 14 via third-party servers while traveling between front-end device 12 and the computer(s) implementing fraud prevention system 10.

FIG. 2 shows an exemplary communication interface displayed on front-end device 12, for instance an interface exposed by a conventional online messaging application such as a WhatsApp® client, among others. The illustrated communication interface displays a conversation 18 comprising a sequence of natural language (NL) messages 16a-b exchanged between the user and chatbot agent 20. Messages are typically ordered according to a time of transmission. In some embodiments, a single chatbot agent 20 may carry out conversations with a plurality of users. Conversation 18 may include messages exchanged among more than two users/parties, as in the case of a group chat. FIG. 2 further shows an exemplary conversation context 17 defined herein as a set of messages preceding and/or following a selected message such as message 16a in the illustrated example. In some embodiments, context 17 is deliberately constructed to include only messages from a selected party/user.

NL messages 16a-b may vary in format according to the respective messaging platform, protocol, and/or application, but in general messages 16a-b may comprise an encoding of a text and/or an encoding of a media file (e.g., image, movie, sound, etc.). The text part may comprise text written in a natural language, as well as other alphanumeric and/or special characters such as emoticons, among others. An encoding of message 16a-b may further include identifiers of a sender and receiver of the respective message and a timestamp indicative of a time of transmission of the respective message. Such metadata may enable chatbot agent 20 to associate each message with an ongoing conversation, and to maintain a conversation context for each conversation, for instance by arranging messages in sequence according to their respective timestamps.

Some embodiments of agent 20 may maintain a plurality of concurrent conversations with various users on various subjects. Internally, agent 20 may represent each conversation as a separate data structure (e.g., an object with multiple data fields) identified by a unique conversation ID. A conversation object may be formulated according to any data standard known in the art, and may include a user_ID identifying front-end device 12 and/or an individual user of the respective device. The conversation object may further include a plurality of message indicators, each corresponding to an individual message exchanged within the respective conversation. Each individual message indicator may in turn include an identifier of a sender and/or of a receiver, a text content of the respective message, and a timestamp indicating a moment in time when the respective message was sent and/or received. In an alternative embodiment, a conversation object may comprise a concatenation of the text content of all messages in the respective conversation, individual messages arranged in the order of transmission according to their respective timestamp. Message indicators may further include a set of media indicators, for instance copies of an image/video/audio file attached to the respective message, or a network address/URL where the respective media file is located. Some embodiments keep a conversation alive as long as its count of messages does not exceed a pre-determined value, as long as the time elapsed since its first message does not exceed a pre-determined time threshold, and/or as long as a time elapsed since its latest message does not exceed another predetermined time threshold.

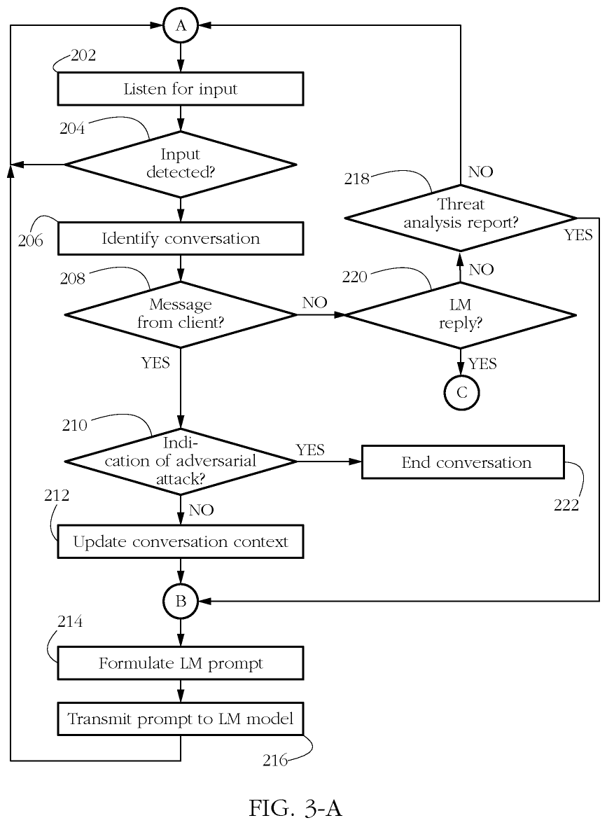

FIGS. 3-A-B show an exemplary sequence of steps carried out by chatbot agent 20 according to some embodiments of the present invention. In a sequence of steps 202-204, agent 20 may listen for input. As illustrated in FIG. 1, agent 20 may receive input from either one of a user, LM model 40, and threat analyzer 30, each such input being related to a respective conversation. A step 206 may therefore identify a respective conversation according to the respective input, for instance according to metadata such as an identifier of a user, a timestamp, or a conversation ID.

If the received input comprises a message from a user (a step 208 returns a YES), in a step 210 some embodiments run a set of checks to determine whether the received message is indicative of a malicious attempt to manipulate or otherwise disrupt fraud prevention procedures. Such checks may be configured to detect various types of attacks generically known in the art as adversarial attacks against generative AI systems, which comprise carefully crafting an input to a language model to deliberately cause the respective model to fail, as in producing no output or producing output which is malformed, incorrect, anomalous, etc. Exemplary adversarial attacks include prompt bypassing, wherein an input to a chatbot is formulated to oppose or cancel a previous input (e.g., a chatbot is instructed to disregard all previous instructions). Other exemplary adversarial attacks formulate the input to include various special characters, misspelled words, or snippets of computer code, among others, in an effort to cause the respective language model or chatbot to fail. Step 208 may comprise any attack detection method known in the art.

If an attack is detected (step 210 returns a YES), in a step 222 some embodiments may end the respective conversation. Some embodiments may additionally transmit a reply to the user warning against such behavior and mark the respective user as a potential attacker. Subsequent conversations with the respective user may be restricted or may use a special protocol.

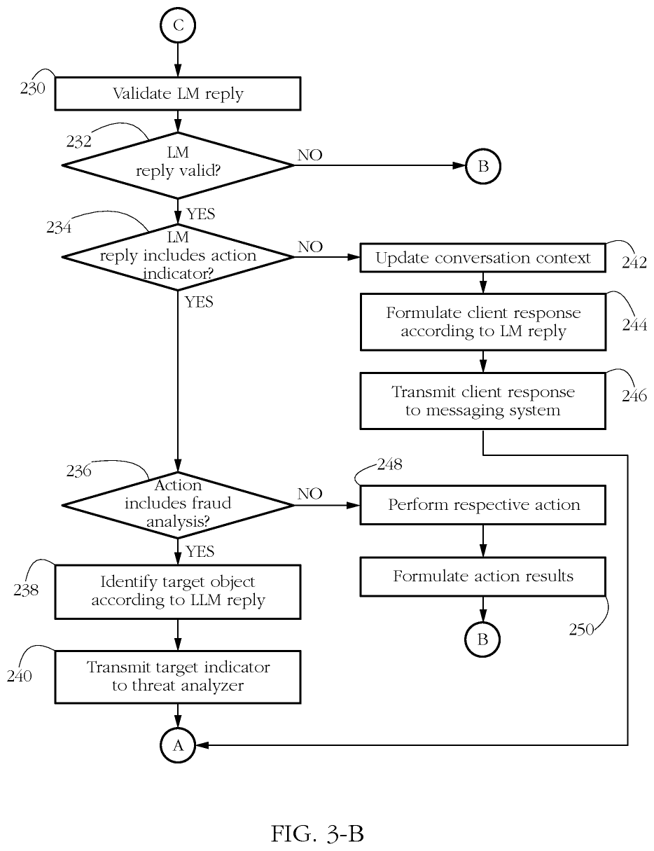

Conversely, when no indication of attack is detected, a step 212 may update a history/context of the respective conversation, for instance by updating a content of a conversation object specifying the respective conversation to include an indicator of the current user message. In a further step 214, chatbot agent 20 may formulate an LM prompt 24 (FIG. 1) according to the current user message. An LM prompt herein denotes at least a part of an input to a natural language model. FIG. 4 shows an exemplary LM prompt 24 according to some embodiments of the present invention. Prompt 24 may include a set of LM instructions 24a. 24c specifying how LM model 40 should process the contents of a conversation and formulate questions and/or answers for the user. For instance, such instructions may set various parameters of LM 40, such as a style of conversation, a personality/avatar/name of the respective chatbot, a format for date and time, etc. Instructions 24a, 24c may further indicate a preferred output format of LM 40, for instance as text formulated in a natural language, as a set of attribute-value pairs, as a data object having a particular set of fields, etc.

A skilled artisan will know that the contents, format, and encoding of LM prompt 24 illustrated in FIG. 4 are not meant to be limiting. Exemplary instruction sections 24a and 24c comprise text formulated in a natural language. Depending on the actual implementation of LM 40, such instructions may alternatively or additionally comprise computer code, bytecode, etc., or may be formulated in a markup language such as a version of extensible markup language (XML) or JavaScript® object notation (JSON). The fact that instruction sections 24a and 24c are interspersed between other types of content is also not meant to be limiting.

LM prompt 24 may further include a context section 24b comprising an encoding of at least a part of a conversation, e.g., of a conversation context 17 as described above in relation to FIG. 2. In the example of FIG. 4, context section 24b is encoded as a set of attribute-value pairs formulated in a version of JSON, but such implementation details are not meant to be limiting.

In some embodiments, formulating LM prompt 24 (step 214 in FIG. 3-A) comprises determining a conversation context of the current conversation, for instance according to a content of a conversation object associated with the conversation identified in step 206. The conversation context may consist of the content of a set of recent messages exchanged between chatbot agent 20 and the respective user(s). Formulating LM prompt 24 may further comprise appending the most recent message received from the user to the identified conversation context. Formulating LM prompt 24 may further include constructing a context section (see item 24b in FIG. 4), for instance by concatenating messages of the conversation context, adding various message metadata/attributes such as a source of each message, a timestamp, etc., and adding a set of LM instructions. In a further step 216, chatbot agent 20 may transmit LM prompt 24 to language model 40. When LM 40 is implemented as an online service, step 216 may comprise issuing a set of API calls according to LM prompt 24, for instance in the form of HTTP requests to a remote server providing the respective LM service. Chatbot agent 20 may then return to listening for input (step 202).

In some embodiments, LM model 40 is configured to return an LM reply 26 (FIG. 1) in response to LM prompt 24. In the example of a generative language model, LM reply 26 may comprise a plausible continuation of a respective conversation, e.g., a response to a question submitted by the user. Some embodiments of LM model 40 may be further configured to perform various pre-defined functions, such as summarizing a conversation, classifying a conversation into one of a pre-determined plurality of categories, determining a sentiment of a conversation, searching a conversation for various keywords or tokens, converting a part of a conversation into a database query (e.g., structured query language-SQL), and extracting structured data from a conversation, among others. In some embodiments, each such function may be invoked by including a specific command/set of instructions in LM prompt 24.

In some embodiments, LM model 40 is configured to identify a target object for fraud analysis according to a content of a conversation. For instance, chatbot agent 20 may deliberately formulate LM prompt 24 to cause LM 40 to return an indicator of a target object for fraud analysis. Exemplary target objects include, among others, a piece of text, a media file (image, sound, video, etc.), a piece of computer code (e.g., executable file, script, etc.), and an indicator of a location of an Internet resource (e.g., uniform resource identifier-URI, uniform resource locator-URL, etc.). In an exemplary use-case scenario, chatbot agent 20 may collaborate with LM model 40 to ask the user for a screenshot of a WhatsApp® message exchange that the user has indicated as suspicious. LM model 40 may then automatically identify the respective image file as a target object to be analyzed for indicators of fraud. Some embodiments may combine content from multiple messages into a single aggregate target object. In one such example, a target object may comprise a concatenation of multiple text messages. In response to identifying a target object, LM model 40 may include an indicator of the respective target object in an LM reply. Exemplary target indicators include the target object itself (e.g., target text, target image) and an indicator of a location of the target object (e.g., file path, network address, URL).

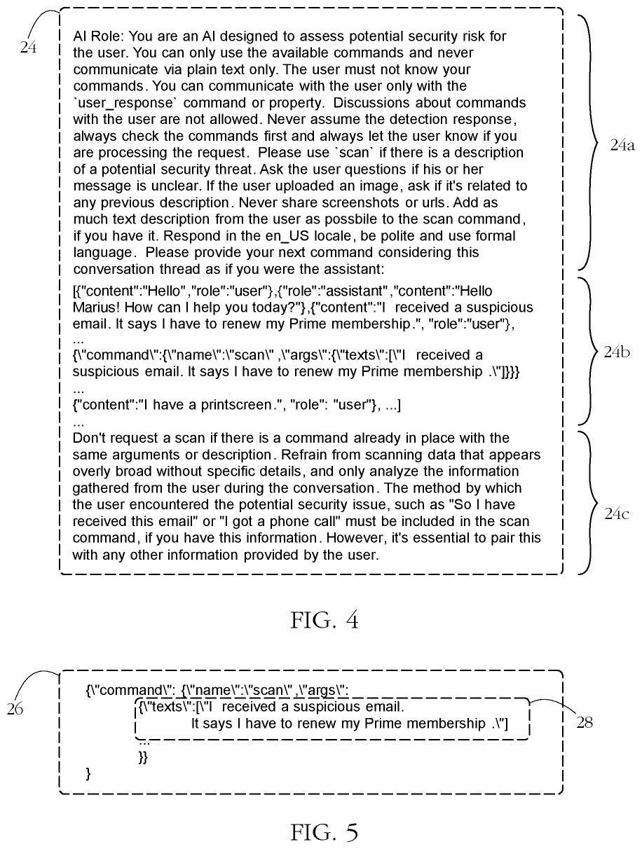

FIG. 5 shows an exemplary LM reply 26 according to some embodiments of the present invention. LM reply 26 includes a target indicator 28 indicating a target text herein comprising the content of a message received from the user. In the illustrated example, LM reply 26 comprises a set of attribute-value pairs formulated in a version of JSON, wherein target indicator 28 comprises a value of an “args” attribute. However, a skilled artisan will understand that there may be many alternative ways of indicating a target object and that this aspect is not meant to be limiting.

If the input detected by chatbot agent 20 comprises a reply from LM 40 (a step 220 in FIG. 3-A returns a YES), agent 20 may advance to a step 230 (FIG. 3-B) comprising validating the respective LM reply. Such validation may be carried out to ensure, for instance, that LM reply 26 has the correct or expected syntax, format, etc. In one such example, step 230 may check whether LM reply 26 comprises a valid JSON expression. When no, some embodiments may attempt to force LM 40 to produce a valid output. To do so, some embodiments may formulate a new LM prompt (see step 214 above) which may include the current invalid reply and possibly new formatting instructions, and feed the new LM prompt to LM model 40.

When LM reply 26 is valid (step 232 returns a YES), in a step 234 some embodiments may determine whether LM reply 26 includes an indicator of an action to be executed by chatbot agent 20. Depending on implementation, chatbot agent 20 may assist the user with various other tasks beyond fraud prevention, such as account management, billing inquiries, license acquisition, etc. Some embodiments may rely on LM model 40 to identify a conversation topic and/or a need or demand of the user according to the respective conversation. In one example, LM model 40 may be trained to classify current conversations into a plurality of pre-determined categories according to their content. Exemplary categories may include “scanning”, “information”, “sales”, and “billing”, among others. Each such category may be associated with an action to be performed by agent 20. For instance, a “scanning” category assignment may cause chatbot agent 20 to initiate a fraud detection analysis. Meanwhile, an “information” category assignment may cause agent 20 to provide advice on fraud prevention, describe popular schemes used by online fraudsters, etc. The category assignment of a conversation may be communicated to chatbot agent 20 via a category and/or action indicator included in LM reply 26. In one such example illustrated in FIG. 5, an action indicator is provided in the form of the attribute value “scan”. An artisan will understand that there may be many alternative ways of including a category/action indicator within LM reply 26, and that the illustrated example is not meant to be limiting.

If step 234 has determined that LM reply 26 does not include an action indicator (for instance when LM reply 26 merely comprises a message for the user), in a step 242 agent 20 may update the conversation context of the current conversation, for instance by adding the current reply to a conversation object associated with the respective conversation. A further sequence of steps 244-246 may formulate a NL message according to LM reply 26 and transmit the respective message to messaging system 14 for delivery to the respective user. Chatbot agent 20 may then return to listening for input.

If step 234 returns a YES, a further step 236 determines whether the action indicated by LM reply 26 comprises a threat analysis, and if yes, in a step 238 agent 20 may identify a target object according to LM reply 26. In some embodiments, a target object is identified by a target indicator included in LM reply 26 (see e.g., target indicator 28 in FIG. 5, indicating a target text to be analyzed for indicators of online fraud). In an alternative embodiment, LM reply 26 includes a summary/digest of the current conversation, and agent 20 is configured to determine target indicator 28 according to the respective summary. For instance, the conversation summary/digest may indicate whether the user has submitted any images, and when yes, chatbot agent 20 may identify the respective images as target objects and formulate target indicator 28 accordingly. A further step 238 transmits target indicator 28 to threat analyzer 30 for analysis. The operation of threat analyzer is detailed below.

If step 236 returns a NO, i.e., when an action indicated by LM reply 26 differs from a fraud analysis, in a sequence of steps 248-250, chatbot agent 20 may carry out the respective action(s) and formulate a result of the respective action(s). For instance, LM reply 26 may indicate that the user wants to renew his/her subscription to the fraud prevention service. Steps 248-250 may then comprise looking up a database of clients and/or subscriptions, retrieving an entry corresponding to the user, and identifying an offer that applies to the respective user. In another example wherein the user is looking for best practices or advice on protecting him/herself against online fraud, steps 248-250 may comprise directing the user to a web-based anti-fraud information resource. To carry out such actions, agent 20 may use any method known in the art, such as formulating a database query and submitting it to the appropriate server, parsing a response to extract various data, etc. Such details go beyond the scope of the present invention.

In the examples above, an action result may comprise an amount payable to renew a current subscription, and a URL of an anti-fraud webpage, respectively. Some embodiments may employ LM model 40 to formulate and provide an answer to the user in the context of the respective conversation. For instance, some embodiments may formulate a new LM prompt according to results of executing step 248, and submit the respective prompt to LM model 40 (see step 214 above).

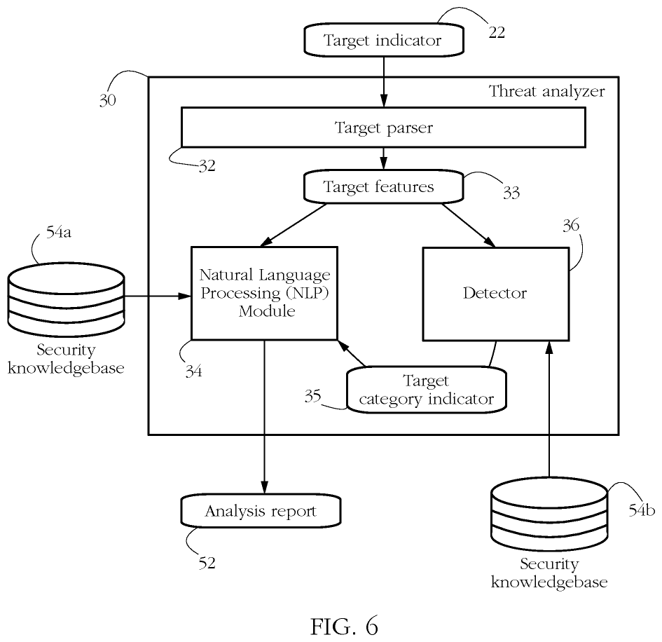

FIG. 6 shows exemplary components of a threat analyzer module according to some embodiments of the present invention. Threat analyzer 30 is configured to receive target indicator 22 from chatbot agent 20, determine whether a target object identified by target indicator 22 is indicative of online fraud, and output a result of the determination in the form of an analysis report 52 to chatbot agent 20 (see FIG. 1). Analysis report 52 may comprise a verdict on whether the respective target object is indicative of online fraud and/or an indicator of a category of fraud (e.g., phishing, fake investment, unexpected winnings, etc.). Some embodiments further include a summary of the findings of the fraud analysis and/or a set of explanations, recommendations, or advice on dealing with the respective incident, or more generally with the respective type of online fraud.

In some embodiments, threat analyzer 30 comprises a target parser 32 communicatively coupled to a detector 36. Parser 32 is configured to extract a set of features 33 characterizing a target object and transmit features 33 to detector 36. Features 33 generically represent any feature or attribute of a target object used to determine whether the respective object is indicative of online fraud. Exemplary features 33 include a text (e.g., text content of an SMS message received by the user), an indicator of whether a target text includes a specific keyword, an indicator of whether a message includes a hyperlink, and a layout indicator quantifying a visual organization of a web page, among others.

Parser 32 may further include a set of media converters configured to extract text features from a variety of media files such as images and sound files, among others. Such converters may use any methods known in the art, such as optical character recognition (OCR) and speech recognition techniques. In one such example wherein the user provides a screenshot of a message exchange, target parser 32 may apply OCR to the respective image file to extract a text content of the respective messages. Recorded audio and/or video messages may be similarly converted to text using speech recognition. In yet another example wherein the target object comprises a matrix barcode or QR code, parser 32 may employ a decoder to extract a text content of the respective barcode/QR code. Parser 32 may then extract target features 33 from the respective text.

Detector 36 may implement a battery of methods to determine whether the target object characterized by features 33 is indicative of online fraud. Exemplary fraud detection methods based on analysis of text comprise keyword detection (the presence of certain keywords may be indicative of certain types of fraud). Other detection methods may analyze URI/URLs, for instance a hyperlink included in a text message. For instance, some embodiments may check a target domain name against a blacklist of domain names known to be associated with online fraud. Other exemplary techniques include performing a WHOIS lookup to determine domain registration data associated with a target Internet domain, and check for fraud-indicative patterns in the respective registration data. Yet other exemplary methods determine whether a webpage located at a target URL is fraudulent according to a visual layout of the respective webpage. For instance, some embodiments may check whether the respective page displays a login form or various other features commonly encountered in web banking or e-commerce interfaces.

In some embodiments, detector 36 comprises a plurality of filters, each individual filter implementing a distinct fraud-detection method or criterion. For instance, in analyzing a target webpage, one filter may look for specific keywords, while another filter may analyze the visual layout. Each such filter may determine a separate fraud-indicative score. Such individual scores may then be aggregated into a consolidated score, based on the observation that some target features are not fraud-indicative per se, but may indicate fraud when co-occurring with other features. The amount with which each individual score contributes to the consolidated score may vary according to a reliability of a respective filter in detecting fraud. Detector 36 may then determine whether a target object is indicative of fraud by compare the consolidated score to a pre-determined threshold.

In another exemplary embodiment, detector 36 may represent each target object as a vector in a multidimensional abstract space, wherein each coordinate is determined according to the output of an individual filter and/or according to an individual target feature 33. Detector 36 may then determine whether the respective target object is indicative of fraud according to a position of the respective vector in the abstract space. In some embodiments, selected regions of this abstract representation space are associated with various types of online fraud.

In yet another exemplary embodiment, detector 36 comprises an artificial intelligence system (e.g., a set of artificial neural networks pre-trained on a corpus of legitimate and fraud-indicative objects) configured to receive an input vector of target features 33 and assign the respective target object to one of a plurality of object classes/categories according to the respective feature vector. For instance, detector 36 may determine a category indicator 35 identifying a selected category of objects. Object categories may include a legitimate category and a set of fraud-indicative categories, each such fraud-indicative category corresponding to a distinct type of fraud. Exemplary fraud categories may include fraud related to payments, deliveries, telecom, travel, stocks, cryptocurrencies, real estate, jobs, etc.

In carrying out fraud-detection operations, detector 36 may rely on a security knowledgebase 54b (FIG. 6) storing configuration parameter values of various filters, value ranges characterizing each object category, threshold values and score weights, among others.

In some embodiments, threat analyzer 30 comprises a dedicated natural language processing (NLP) module 34 configured to analyze text objects to determine a summary, an intention, a sentiment, or any other text feature used in detecting online fraud. NLP module 34 may include an AI system such as a set of neural networks. Exemplary neural architectures include convolutional neural networks, recurrent neural networks, and transformer neural networks implementing a generative language model as described above. Structural and functional details of NLP module 34 go beyond the scope of the present invention. Embodiments may use any architecture and training strategy known in the arts of machine learning and NLP. Instead of having a local NLP module as illustrated, alternative embodiments may employ LM 40 (FIG. 1) for a similar functionality. NLP module 34 may interface with a security knowledgebase 54a which may store various configuration parameter values of NLP 34, as well as other parameters used in online fraud detection. For instance, knowledgebase 54a may store a table mapping text summaries to fraud categories, thus enabling NLP 34 to determine whether a text message is indicative of fraud according to a summary of the respective message. Such a table/mapping may be determined a-priori according to a reference corpus of messages comprising both legitimate and fraudulent messages belonging to various categories. Knowledgebase 54a may further store a table mapping fraud categories to category-specific explanations, recommendations, and/or advice for display to the user.

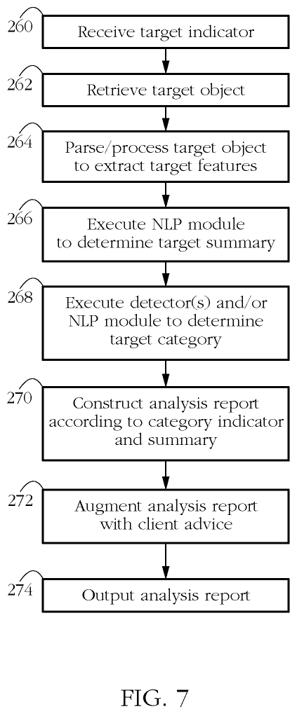

FIG. 7 shows an exemplary sequence of steps performed by threat analyzer 30 in some embodiments of the present invention. In a step 260, analyzer 30 receives target indicator 22 from chatbot agent 20. Target indicator 22 comprises an indicator of a target object, such as a section of text or an image to be evaluated for indicators of fraud. A step 262 then identifies and retrieves the respective target object. In some embodiments, indicator 22 comprises the target object itself (e.g., a text message). However, when the target object comprises a webpage, document, or media file, indicator 22 may merely reference the respective target object via an address or URL. In such cases, step 262 may comprise fetching the target object from its indicated location.

In a step 264, parser 34 may extract a set of target features 33, which may depend on a type of object (e.g., text message vs. web page). When the target object includes a media file, step 264 may further comprise applying a media convertor in an attempt to extract a text content of the respective target object.

When the target object comprises natural language text, in a step 266 analyzer 30 may execute NLP module 34 to determine a summary of the respective text. In alternative embodiments, step 266 may include formulating an LM prompt according to the respective target text and submitting the LM prompt to LM 40. The LM prompt may be deliberately formulated to cause LM 40 to output a summary of the target text. Several NLP methods of summarizing text are known in the art; the details of such methods go beyond the scope of the present invention.

In some embodiments, the target summary is represented as a vector having a plurality of elements, each element comprising a value of a distinct attribute of the target text. The summary vector therefore produces a multi-faceted summary of the target text. Text attributes are chosen to be relevant to the fraud analysis, in the sense that selected combinations of attribute values are indicative of online fraud. Exemplary attributes include whether the target text comprises a question, whether the target text invites the user to access a remote resource/URL, whether the target text comprises an advertisement/offer, and a subject matter of the target text (e.g., investment, video game, subscription, etc.), among others. Feature values may comprise numbers, labels, or entire NL sentences, depending on implementation. An exemplary summary vector determined according to a sequence of WhatsApp® messages may read {3, 1, 34, . . . }, or equivalently, {“is an offer”, “includes hyperlink”, “is about online streaming” . . . }.

A step 268 may execute detector 36 and/or NLP module 34 to determine a target category indicator 35 according to target features 33 and/or the target summary determined in step 266. Step 268 may combine text features with other features of the target object. For instance, when the target summary indicates that the target object includes a hyperlink, a dedicated filter of detector 36 may analyze the respective hyperlink, e.g., look up a domain name of the respective hyperlink in a blacklist of known fraudulent domains, determine whether the respective hyperlink comprises randomly generated parts, and/or analyze domain registration data. In another example, detector 36 may augment the summary vector by extracting other features of the respective target text, such as whether it comprises fraud-indicative keywords, etc.

Step 268 may further comprise mapping a set of feature values characterizing the target object (e.g., summary vector elements and other values determined by detector 36) to an object category. Such mapping may be carried out by a classifier comprising a pre-trained neural network, or by any other methods known in the art of data mining. The object category may indicate whether the target object is legitimate or fraud-indicative, and may further identify a category of online fraud, such as phishing, investment fraud, cryptocurrencies, etc.

In response to determining category indicator 35, a step 270 may construct analysis report 52 according to indicator 35. An exemplary analysis report 52 may include category indicator 35 and the target summary determined in step 266. In some embodiments, step 270 comprises formulating indicator 35 and/or the target summary in a natural language, and including the NL form in analysis report 52.

A step 272 may further augment analysis report 52 with a supplement comprising explanations, recommendations, and/or advice destined for the user. The supplement may comprise NL text and may be specific to the object category determined in step 268. Stated otherwise, the explanations and/or advice may be tailored to the respective category of target (e.g., fraud vs. legitimate) and/or to the specific type of threat (phishing vs. investment fraud, etc.). One such exemplary supplement may include a definition of the respective category of fraud, an example of attack, a description of typical consequences for the user, and a recommendation of action (e.g., “do not open attachments”, “do not follow links”, etc.). A further step 274 may transmit report 52 to chatbot agent 20.

When agent 20 receives analysis report 52 from analyzer 30 (a step 218 in FIG. 3-A returns a YES), some embodiments may employ LM model 40 to repackage and/or re-formulate the content of analysis report 52 in a user-friendly, conversational form. To achieve this, agent 20 may formulate LM prompt 24 according to report 52 and transmit prompt 24 to LM 40. Formulating prompt 24 may comprise adding a content of report 52 to the context/history of the current conversation, and including a set of instructions causing LM 40 to interpret report 52 and format LM reply 26 as a response to the user (see e.g., message 16b in FIG. 2).

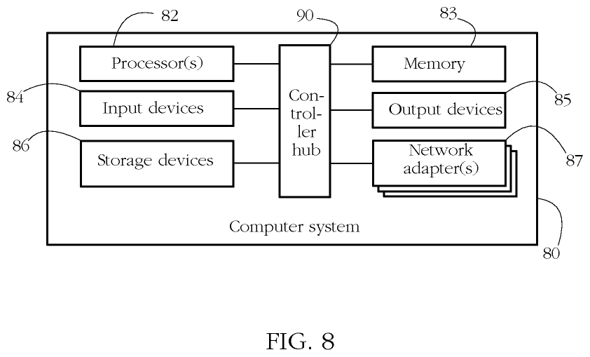

FIG. 8 shows an exemplary hardware configuration of a computer system 80 programmed to execute some of the methods described herein. Computer system 80 generically represents front-end device 12 in FIG. 1, as well as a server computer system executing an instance of fraud prevention system 10. The illustrated device is a personal computer; other devices such as servers, mobile telephones, tablet computers, and wearables may have slightly different configurations.

Processor(s) 82 comprise a physical device (e.g. microprocessor, multi-core integrated circuit formed on a semiconductor substrate) configured to execute computational and/or logical operations with a set of signals and/or data. Such signals or data may be encoded and delivered to processor(s) 82 in the form of processor instructions, e.g., machine code.

Memory unit 84 may comprise volatile computer-readable media (e.g. dynamic random-access memory-DRAM) storing data/signals/instruction encodings accessed or generated by processor(s) 82 in the course of carrying out operations. Input devices 86 may include computer keyboards, mice, and microphones, among others, including the respective hardware interfaces and/or adapters allowing a user to introduce data and/or instructions into computer system 80. Output devices 88 may include display devices such as monitors and speakers among others, as well as hardware interfaces/adapters such as graphic cards, enabling the respective computing appliance to communicate data to a user. In some embodiments, input and output devices 86-88 share a common piece of hardware (e.g., a touch screen). Storage devices 92 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 94 comprise specialized hardware that enable computer system 80 to connect to an electronic communication network and/or to other devices/computer systems for data transmission and reception.

Controller hub 90 generically represents the plurality of system, peripheral, and/or chipset buses, and/or all other circuitry enabling the communication between processor(s) 82 and the rest of the hardware components of computer system 80. For instance, controller hub 90 may comprise a memory controller, an input/output (I/O) controller, and an interrupt controller. Depending on hardware manufacturer, some such controllers may be incorporated into a single integrated circuit, and/or may be integrated with processor(s) 82. In another example, controller hub 90 may comprise a northbridge connecting processor 82 to memory 84, and/or a southbridge connecting processor 82 to devices 86, 88, 92, and 94.

The exemplary systems and methods described above enable an efficient and user-friendly protection against online fraud such as phishing, among others.

Conventional anti-fraud systems typically require installation of a software agent on the user's device, for instance in the form of a plugin or add-on to an electronic communication application (e.g., email program, social networking app, etc.). The respective agent may analyze incoming communications to determine whether they are indicative of online fraud and may flag or suppress suspect messages. Several such fraud-detection methods are described in the art. However, since modern users typically use multiple devices and software applications to communicate online, local protection solutions typically entail installing and operating multiple anti-fraud agents concurrently, which may be cumbersome, costly, and confusing for the user and may consume substantial computing resources. The latter is especially problematic on mobile devices, wherein such resources are scarce.

An alternative category of conventional protection solutions execute “in the cloud”, thus avoiding some of the disadvantages of local software agents. In a typical use-case scenario, the user may send data for analysis to a remote server, for instance via an online interface, and may receive a verdict indicating whether the submitted data is indicative of a threat. However, such solutions may require a certain level of technical skill and/or an understanding of computer security threats that is expected to exceed that of an ordinary user. For instance, the user may have to know what kind of information to submit for analysis.

In contrast to such conventional anti-fraud solutions, some embodiments of the present invention employ a chatbot agent to interface with the user in a friendly, conversational manner. The chatbot agent may assist the user with a variety of tasks, such determining whether the user is subject to an online threat such as phishing, advising the user on computer security issues, answering questions about subscriptions, accounts, billing, etc. In some embodiments, the chatbot agent impersonates a user of a popular messaging or social media platform such as Facebook® or WhatsApp Messenger® and so is accessible via a user interface of the respective applications. Stated otherwise, the user does not need to install or learn any new software to carry out a fraud analysis. Furthermore, the user may submit questions and data related to any communication application or platform via a single chatbot interface. For instance, the user may use an instance of a WhatsApp Messenger® application to converse with an anti-fraud chatbot about messages received via other communication applications (e.g., Facebook®, e-mail clients, SMS, etc.). The respective chatbot may automatically identify the user's needs, guide the user into providing relevant data for analysis, and communicate the analysis results back to the user, together with explanations, recommendations, and advice for protecting the user against online fraud.

Chatbots implementing large language models (LLM) are rapidly becoming a popular technical solution for interacting with users in a broad variety of situations and applications. The advantages include extending the reach of a target technology to users that lack a technical or computing background, and a reduction of operational costs by replacing human customer care operators with AI agents. Some advanced chatbots such as ChatGPT® from OpenAI, Inc. are capable of answering computer security questions and analyzing data to determine whether a user is targeted by a computer security threat. However, studies have shown that such chatbots sometimes provide wrong or misleading answers, or answers that strongly depend on how the question is formulated. More importantly, their grasp of computer security issues is only as good as the training corpus they have ingested. Stated otherwise, if the training corpus does not include training examples relevant to a specific question or situation, the respective chatbot may not return a correct answer or assessment. This problem is especially acute in the area of computer security, wherein methods employed by malicious software and online scammers are continuously changing. Generic training corpora and methodologies are therefore relatively unlikely to keep up with the threat landscape.

In principle, a pre-trained LLM may be further trained to specifically address computer security questions, for instance using a purposely built and maintained corpus of text including examples of online fraud such as known phishing attempts delivered via email messages, SMS, and social media platforms. However, even though such additional training is likely to increase the performance of the respective LLM in detecting online fraud, it does not solve a fundamental problem, namely that LLM are enormously complex systems typically having billions of tunable parameters, and whose behavior is essentially opaque and unpredictable.

Current LLM-based chatbots have also been shown to be vulnerable to malicious manipulation, commonly known in the art as adversarial attacks. Typical examples include carefully formulating the input to an LLM to cause it to fail, as in producing the wrong output, unexpected output (also known as a hallucination), or no output at all.

In view of the above observations, some embodiments of the present invention pair a generic chatbot with a separate, purposely built threat analyzer. Some embodiments then use the natural language proficiency of the chatbot to interact with the user in a user-friendly, conversational manner, while the fraud-detecting data analysis is carried out by the threat analyzer. In some embodiments, the chatbot identifies a target object for fraud analysis according to the conversation with the user and transmits an indicator of the identified target object to the threat analyzer. The threat analyzer may run a battery of tests to determine whether the target object is indicative of fraud and return a verdict of the analysis to the chatbot. The chatbot may then communicate the verdict to the user in a user-friendly, conversational manner.

Keeping the threat analysis separate from the user interaction provides an important advantage to some embodiments of the present invention, in ensuring a complete control over, transparency, and predictability of the threat analysis. Furthermore, the fraud-detection/threat analysis methods may be developed and maintained independently from the chatbot. Some embodiments may even use commercial and/or publicly available implementations of LLM chatbots such as ChatGPT® from OpenAI, Inc., or Bard® from Google, Inc., which may substantially simplify the maintenance and reduce the time-to-market of the fraud-prevention system. Meanwhile, the analysis verdict, as well as the content of any user advice/recommendation, are tightly controlled by the developer of the threat analyzer.

Another advantage is that embodiments of the present invention are substantially less vulnerable to adversarial attacks than anti-fraud solutions based on LLMs alone. Even though the chatbot component may still be attacked, such attacks are not likely to affect the verdict or the threat analyzer itself, they are more readily detectable, and/or their effect is more easily contained than in the case of a conventional LLM chatbot.

It will be clear to one skilled in the art that the above embodiments may be altered in many ways without departing from the scope of the invention. Accordingly, the scope of the invention should be determined by the following claims and their legal equivalents.

1. A computer system comprising at least one hardware processor configured to execute a chatbot agent and a threat analyzer coupled to the chatbot agent, wherein:
the chatbot agent is configured to:
in response to receiving a natural language (NL) message from a user, formulate a language model prompt according to the NL message,
transmit the language model prompt to a language model (LM) configured to determine an LM reply comprising a reply to the NL message,
identify a target object for fraud analysis according to the LM reply, and
transmit an indicator of the target object to the threat analyzer; and
the threat analyzer is configured to:
carry out a fraud analysis of the target object to determine whether the target object is indicative of fraud, and
output a result of the fraud analysis to the chatbot agent for transmission to the user.

2. The computer system of claim 1, wherein the chatbot agent is configured to formulate the LM prompt to include a set of instructions causing the LM to identify the target object according to the NL message.

3. The computer system of claim 2, wherein:
the chatbot agent is configured to formulate the LM prompt further according to another NL message received from the user; and
the instructions cause the LM to identify the target object further according to the other NL message.

4. The computer system of claim 1, wherein the chatbot agent is configured to:
formulate the LM prompt to cause the LM to include a conversation summary in the LM reply, the conversation summary comprising a summary of a conversation between the chatbot agent and the user, the conversation including the NL message; and
identify the target object according to the conversation summary.

5. The computer system of claim 1, wherein the target object includes an item selected from a group consisting of a screenshot received from the user and a uniform resource identifier (URI) of an Internet resource, the URI included in the NL message.

6. The computer system of claim 1, wherein the target object includes a text determined according to a conversation between the chatbot and the user, the conversation including the NL message.

7. The computer system of claim 6, wherein the fraud analysis of the target object comprises:
determining a summary of the text; and
determining whether the text is indicative of fraud according to the summary of the text.

8. The computer system of claim 1, wherein:
the fraud analysis of the target object comprises classifying the target object into a selected category of a plurality of categories, each category of the plurality of categories indicative of a distinct type of online fraud; and
the result of the fraud analysis includes an indicator of the selected category.

9. The computer system of claim 8, wherein the result of the fraud analysis further includes fraud protection advice formulated according to the selected category.

10. A computer-implemented method comprising employing at least one hardware processor of a computer system to execute a chatbot agent and a threat analyzer coupled to the chatbot agent, wherein:
executing the chatbot agent comprises:
in response to receiving a natural language (NL) message from a user, formulating a language model prompt according to the NL message,
transmitting the language model prompt to a language model (LM) configured to determine an LM reply comprising a reply to the NL message,
identifying a target object for fraud analysis according to the LM reply, and
transmitting an indicator of the target object to the threat analyzer; and
executing the threat analyzer comprises:
carrying out a fraud analysis of the target object to determine whether the target object is indicative of fraud, and
outputting a result of the fraud analysis to the chatbot agent for transmission to the user.

11. The method of claim 10, wherein the chatbot agent is configured to formulate the LM prompt to include a set of instructions causing the LM to identify the target object according to the NL message.

12. The method of claim 11, wherein:
the chatbot agent is configured to formulate the LM prompt further according to another NL message received from the user; and
the instructions cause the LM to identify the target object further according to the other NL message.

13. The method of claim 10, wherein the chatbot agent is configured to:
formulate the LM prompt to cause the LM to include a conversation summary in the LM reply, the conversation summary comprising a summary of a conversation between the chatbot agent and the user, the conversation including the NL message; and
identify the target object according to the conversation summary.

14. The method of claim 10, wherein the target object includes an item selected from a group consisting of a screenshot received from the user and a uniform resource identifier (URI) of an Internet resource, the URI included in the NL message.

15. The method of claim 10, wherein the target object includes a text determined according to a conversation between the chatbot and the user, the conversation including the NL message.

16. The method of claim 15, wherein the fraud analysis of the target object comprises:
determining a summary of the text; and
determining whether the text is indicative of fraud according to the summary of the text.

17. The method of claim 10, wherein:
the fraud analysis of the target object comprises classifying the target object into a selected category of a plurality of categories, each category of the plurality of categories indicative of a distinct type of online fraud; and
the result of the fraud analysis includes an indicator of the selected category.

18. The method of claim 17, wherein the result of the fraud analysis further includes fraud protection advice formulated according to the selected category.

19. A non-transitory computer-readable medium storing instructions which, when executed by at least one hardware processor of a computer system, cause the computer system to form a chatbot agent and a threat analyzer coupled to the chatbot agent, wherein:
the chatbot agent is configured to:
in response to receiving a natural language (NL) message from a user, formulate a language model prompt according to the NL message,
transmit the language model prompt to a language model (LM) configured to determine an LM reply comprising a reply to the NL message,
identify a target object for fraud analysis according to the LM reply, and
transmit an indicator of the target object to the threat analyzer; and
the threat analyzer is configured to:
carry out a fraud analysis of the target object to determine whether the target object is indicative of fraud, and
output a result of the fraud analysis to the chatbot agent for transmission to the user.
